(19) United States
(12) Patent Application Publication
(10) Pub. No.: US 2018/0239724 A1
(43) Pub. Date: Aug. 23, 2018

(54) AUTOMATED HOST SELECTION

(71) Applicant: NANOPORT TECHNOLOGY INC., Markham (CA)

(72) Inventors: Timothy Jing Yin SZETO, Markham (CA); David Michael Lopez REYES, Toronto (CA)

(73) Assignee: NANOPORT TECHNOLOGY INC., Markham (CA)

(21) Appl. No.: 15/753,287

(22) PCT Filed: Aug. 17, 2016
(86) PCT No.: PCT/CA2016/050964

§ 371 Date: Feb. 17, 2018

Related U.S. Application Data
(60) Provisional application No. 62/206,483, filed on Aug. 18, 2015.
(60) Provisional application No. 62/252,975, filed on Nov. 9, 2015.

(51) Int. Cl. G06F 13/22; G06F 13/10; G06F 13/42; H04W 4/02

(52) U.S. Cl. CPC G06F 13/22; G06F 13/102; G06F 2213/0042; H04W 4/02; G06F 13/4282

(57) ABSTRACT

A method of configuring an electronic device capable of acting as a host or slave device to other electronic devices, and a corresponding electronic device are disclosed. The method includes determining a metric representative of the electronic device's readiness to assume the host mode among at least two electronic devices; initiating a timer that times an amount of time inversely proportional to the device's readiness to assume the host mode among the at least two electronic devices; prior to expiry of the amount of time, determining if another of the electronic devices has assumed its host mode, and in response thereto assuming the slave mode; and upon expiry of the amount of time, assuming the host mode.

### CROSS-REFERENCE TO RELATED APPLICATIONS

This application claims priority from U.S. Provisional Application No. 62/206,483 filed on Aug. 18, 2015, and U.S. Provisional Application No. 62/252,975 filed Nov. 9, 2015, the entire contents of which are hereby incorporated by reference.

### TECHNICAL FIELD

This relates to intercommunicating electronic devices, and more particularly to intercommunicating devices operable as hosts and slaves, and to methods of assigning host and slave roles between devices.

### BACKGROUND

Modern serial protocols allow the interconnection of peripheral devices to other computing devices. Example protocols include the Universal Serial Bus (USB) protocols, as specified in the USB Specifications 1.0, 2.0, 3.0 and 3.1, the contents of which are hereby incorporated by reference. Typically, a computing device controls communication with a peripheral device. The peripheral device is typically referred to as a “slave” to the “host” or “master” computing device.

Some devices blur the distinction between host and slave. For example, a typical cellular telephone, interconnected with a personal computing device acts as a slave to the personal computing device. In other configurations, however, the cellular telephone may act as a host to an external memory. In such instances, the port of such device (e.g. the cellular telephone) may act as either a slave port, or a host port, as specified in the USB-OTG standard. The role of each device is decided based on the interconnected cable to the device.

PCT Publication No. WO 2015/070321, the contents of which are hereby incorporated by reference, discloses devices capable of acting as host and slave devices, and the assignment of host and slave roles, based on the relative roles of the devices.

Multiple such devices may be interconnected by way of a hub, as for example disclosed in. U.S. Provisional Patent application No. 62/099,941, the contents of which are hereby incorporated by reference, discloses a configurable device hub whose multiple ports may be arbitrarily assigned to be master or slave ports.

There remains a need for new ways of assigning the relative roles of such devices.

### SUMMARY

According to an aspect, there is provided a method of configuring an electronic device to assume one of a host mode and a slave mode, among at least two electronic devices, the method comprising: determining a metric representative of the device's readiness to assume the host mode among the at least two electronic devices; initiating a timer based on said metric that times an amount of time inversely proportional to the device's readiness to assume the host mode among the at least two electronic devices; prior to expiry of the amount of time, determining if another of the at least two electronic devices has assumed its host mode, and in response thereto assuming the slave mode; and upon expiry of the amount of time, assuming the host mode.

According to another aspect, there is provided a device comprising: a plurality of serial ports for interconnection to other electronic devices; device electronics, operable to act as a host or slave to the other electronic devices and further operable to: determine a metric representative of the device's readiness to assume the host mode among the other electronic devices; commence a timer based on the metric that times an amount of time inversely proportional to the device's readiness to assume the host mode; prior to expiry of the amount of time, determine if another electronic device has assumed its host mode, and in response thereto cause the device electronics to assume their slave mode; and upon expiry of the amount of time, cause the device electronics to assume their host mode.

Other features will become apparent from the drawings in conjunction with the following description.

### BRIEF DESCRIPTION OF THE DRAWINGS

In the figures which illustrate example embodiments,

FIG. 1 is a schematic block diagram of an electronic device;

FIG. 2 is a schematic block diagram of the device of FIG. 1, including a suitable housing;

FIG. 3 is a block diagram illustrating the electronic device of FIG. 1 interconnected with another like electronic device;

FIGS. 4 and 5 are block diagrams of components of the device of FIG. 1;

FIG. 6 is a block diagram of the electronic device of FIG. 1 proximate another like electronic device;

FIG. 7 is a flow chart illustrating the device of FIG. 1, in operation, in an exemplary manner; and

FIG. 8 is a timing diagram illustrating timing of blocks of FIG. 7.

### DETAILED DESCRIPTION

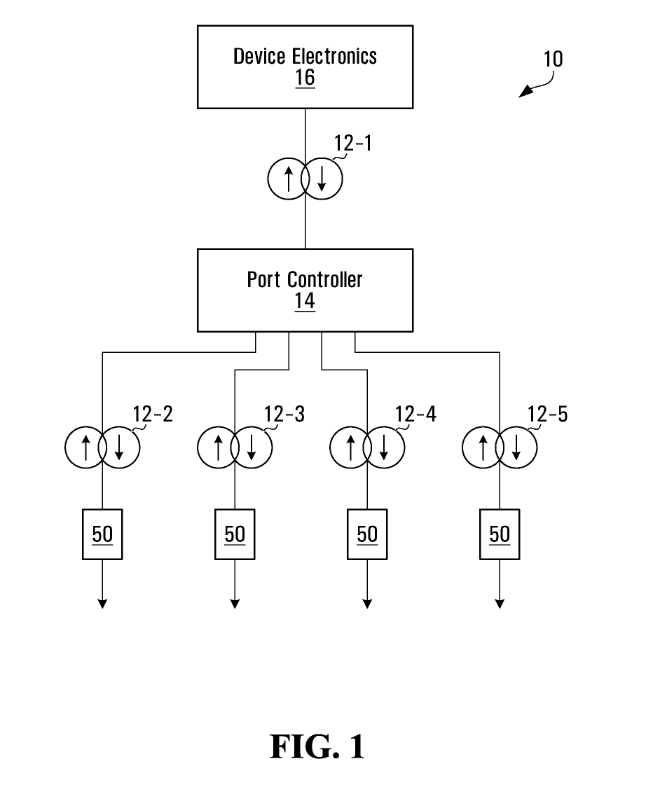

FIG. 1 illustrates an electronic device 10, exemplary of an embodiment of the present invention. As illustrated, device 10 includes plurality of ports 12-1; 12-2; 12-3; 12-4 and 12-5 (individually and collectively port(s) 12), a device port controller 14, and optional device electronics 16. Each port may include one or more physical connectors 50. Only five ports 12 are illustrated. Each of ports 12 is configurable as either a host (master) port or a slave port—that is the ports may be operating in either host mode or slave mode, as for example disclosed in U.S. Provisional Patent Application No. 62/099,941.

As disclosed in PCT Publication No. WO 2015/070321, two similar such devices may be brought into physical proximity to co-operate with one another, with one acting as host—having assumed its host mode—and the other as slave—having assumed its slave mode. In this way, one of the devices may use computing resources of device electronics 16 or other resources of the other in a peripheral capacity. For example, one device may use the memory, display, I/O sensors, camera, etc. of the other.

In the depicted embodiment, device electronics 16 form part of device 10. However, in other embodiments device electronics may form part of a different/separate device. In a practical embodiment, device 10 may be, or may be a part of, a mobile computing device such as a cellular telephone or tablet device or laptop computer, desktop computer, workstation, server, personal digital assistant, interactive television, video display terminal, gaming console, electronic reading device, or any other portable electronic device, or a combination of these. Device 10 may be integrated in other devices—such as a household appliance (e.g., fridge, stove, oven, washing machine, stereo, exercise bike, alarm clock, or the like), or a vehicle (e.g., on a vehicle dashboard), etc. In certain embodiments, device 10 may similarly form a part of a peripheral device, such as a peripheral memory; display; printer; or the like.

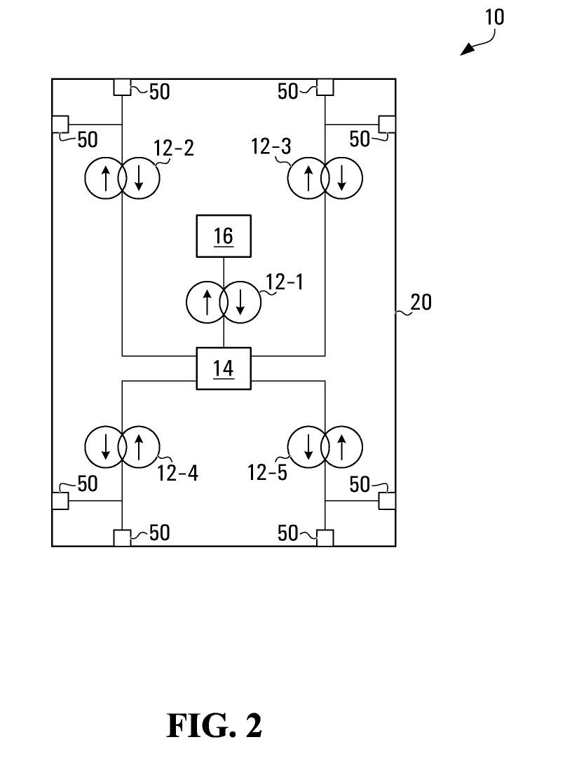

Device 10 may be housed in a housing 30, as schematically depicted in FIG. 2, with connectors 50 located external to housing, for example proximate a corner of housing 30. Other housing geometries will be readily appreciated by a person of ordinary skill.

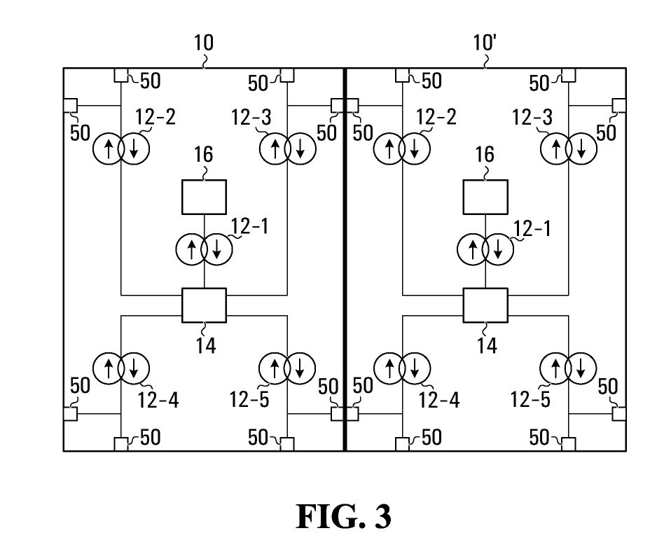

In such an embodiment a device 10 acting as host, may be interconnect with, and use a similar device 10′ as an auxiliary display, audio transducer, or storage device, relying, for example, on the electronics of device 10′, as depicted in FIG. 3, and disclosed in greater detail in PCT Publication No. WO 2015/070321.

In reality, device 10 and device 10′ may have entirely different capabilities, but each should have the ability to act as either host or slave among devices 10 and 10′. For the purposes of this description and in order to simplify explanation, device 10 and device 10′ are depicted as having similar—and possibly identical capabilities. The role of each device 10 or 10′ relative to the other device 10′ or 10, however, as peripheral host or slave is typically not pre-determined. Either device 10′ or 10 may act as host, and the other may act as slave.

The role of each device 10 and 10′ will dictate the state of the device electronics 16 of each device 10 and 10′ as well as the configuration of the ports 12 of each device as host or slave ports—as for example detailed in U.S. patent application Ser. No. 14/875,224, the contents of which are hereby incorporated herein by reference. In FIG. 3, the role of each device 10 and 10′ has not been assigned.

In the example embodiment, device port controller 14 controls the modes of all ports 12 on device 10. A similar device port controller 14′ may control the modes of all ports 12′ on device 10′.

Each of ports 12/12′ may be, for example, a universal serial bus port, compatible with the USB 1.0, 2.0, 3.0 and 3.1 specifications. In other embodiments ports 12/12′ may take other forms—for example ports 12/12′ could be compatible with other serial protocols; ports 12/12′ could be logical wireless ports—using RF or infrared media.

Device 10/10′ may further include a physical port connector 50 for each port 12/12′ as detailed below. Operation of ports 12/12′ as USB ports may be controlled by device port controller 14/14′. Device port controller 14/14′ may also control the configuration of each of ports 12 as a slave port or as a host port, as detailed below.

A suitable device port controller 14/14′ is disclosed in U.S. Provisional Patent Application No. 62/099,941. As disclosed in this application, device port controller 14/14′ may for example receive an external signal indicating which of ports 12/12′ assumes the role of host port, and which assumes the role of a slave port.

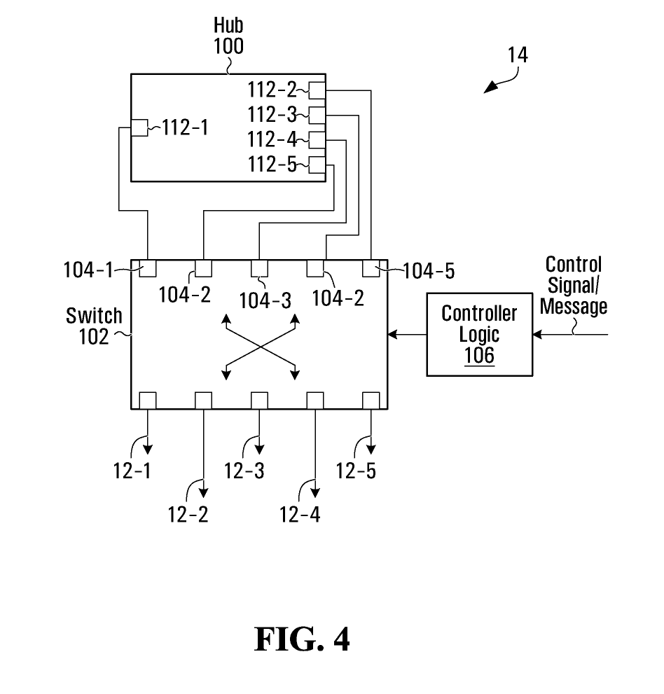

In a particular embodiment, as illustrated in FIG. 4, device port controller 14 may include control logic 106, a hub 100 with statically assigned ports and a many-to-many switch 102. Hub 100 may be a conventional USB hub, and may include a conventional USB hub controller, and a plurality of ports—statically assigned as host ports and slave ports. In the depicted embodiment, hub 100 includes a single host port 112-1 and four slave ports 112-2, 112-3, 112-4 and 112-5 (individually and collectively ports 112) statically configured. Of course, USB hub 102 could include an arbitrary number of ports—only five (5) are illustrated.

A switch 102 includes a plurality of bi-directional internal ports 104-1, 104-2, 104-3, . . . 104-n, (individually and collectively internal port (s) 104). Again, only 5 are depicted. Each internal port 104 may be connected to a port 112 of hub 100. As depicted, internal port 104-1 is connected to hub port 112-1; internal port 104-2 to hub port 112-2; and so on.

Switching fabric 102 also interconnects ports 12-1, 12-2, 12-3, 12-4, 12-5 of device 10. Switching fabric 102 may be a conventional switch providing selectable bi-directional communication, non-blocking paths through the switching fabric 102, each path connecting an internal port 104 with a port 12. In this way, each port 12 may be selectively connected to host port 112-1 or a slave port 112-2, 112-3, 112-4 or 112-5 of hub 100. Selection of these paths is controlled by controller logic 106, which performs the selection according to a control signal received by controller 106. In one specific embodiment, switching fabric 102 may include a conventional multiplexer/demultiplexer.

If a USB host port 112-1 is connected to a port 12 (e.g. port 12-a), that port 12-a may function as a host port. Conversely, if a given port 12 (e.g. port 12-b) is connected to a slave port 112-2, 112-3, 112-4, 112-5, that port 12-b may function as a slave port. Likewise, a given external device interconnected to a host port 12-a should be configured to function as a host device; likewise devices interconnected with a slave port 12-b should be configured to function as a slave device. Insofar as a particular interconnected device can act in either host or slave mode, this device may be dynamically configured, as either a host or slave device, to properly interact with an interconnected one of ports 12.

Switching fabric 102 may be re-configured dynamically during operation, thereby allowing the slave/host roles of devices interconnected to ports 12 to be assigned dynamically during operation, e.g., under software control. For example, an interconnected device may be assigned a new host/slave role and transition to this new role dynamically. That is, an interconnected device may transition from a host to slave, or vice versa.

This interconnect of switching fabric 102 may be changed by switch controller 106, e.g., upon request through a control signal. For example, switch controller 106 may receive a control signal requesting that port 12-2 be connected to internal port 104-2.

Notably, one of ports 12 (in the depicted embodiment port 12-1) of device 10/10′ (e.g. see FIGS. 1-3) may further be interconnected with local device electronics 16, capable of acting as a host or slave to peripheral devices interconnected with the remaining ports 12-2; 12-3; 12-4; and 12-5.

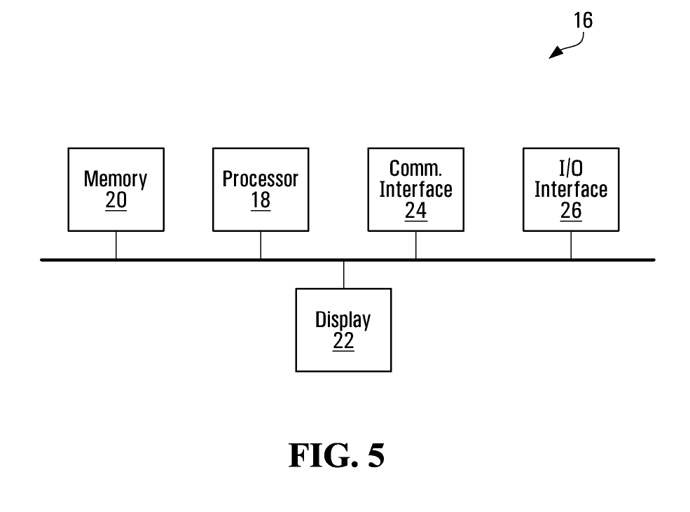

As illustrated in FIG. 5, device electronics 16 may for example, include, one or more processors 18, processor readable memory 20, an optional display 22, one or more input/output interfaces 26; and one or more communications interfaces 24 (e.g. Bluetooth; WiFi; cellular network radio; NFC interface; or the like)—all, as for example, found in a contemporary computing device (e.g. smart phone, laptop, tablet, etc.).

In such an embodiment, ports 12-2, 12-3, 12-4, and 12-5 may have physical port connectors 50 (FIGS. 1 and 2) located on the casing 30 of device 10, exposing ports 12-2, 12-3, 12-4 and 12-5 for interconnection with other devices. Port 12-1 may be internal to device 10 to interconnect device electronics 16 to the remaining ports of device 10. In other embodiments, device 10 may be a hub, with all of ports 12-1; 12-2; 12-3; 12-4, and 12-5 having exposed port connectors for interconnection with other devices.

Suitable port connectors 50 may be standard USB compatible connectors—for example USB Type A Plug/Jack; USB Type B Plug/Jack; USB 2.0/3.0 Micro USB plug/jack; etc. Alternatively, port connectors 50 may be magnetic connectors, as for example detailed in PCT Publication No. WO 2015/070321. If port 12 is wireless, a suitable port connector 50 may take the form of logical port on a wireless interface.

To allow flexible interconnection, each port 12 may be associated with one or more connectors that may be physically exposed for interconnection with complementary port connectors of other devices. In an embodiment, each port 12-2, 12-3, 12-4 and 12-5 may be associated with a connector 50 located near the physical corner of a casing of device 10. Optionally, two connectors may be located near each corner.

Device electronics 16, for example, under software control, may cause port controller 14 to configure ports 12 of device 16, as detailed in U.S. Provisional Patent Application No. 62/099,941. Likewise, device electronics 16 of device 10′ may cause may cause port controller 14 to configure ports 12 of device 16 in a complementary fashion, so that a host controller of one device is properly interconnected with a slave port of the other device, to establish a USB serial bus between device electronics 16 of device 10 and device electronics 16 of device 10′.

Port configuration of each of device 10 and device 10′ will depend on which of these devices assumes the role of host and which assumes the role of slave, and which ports are interconnected to each other. Typically, the slave port of a host device will be interconnected with the host port of a slave device.

In other embodiments, port controller 14 may include its own software/firmware to allow port controller 14 to interact with external processors/controllers directly without utilizing device electronics 16. In yet other embodiments, functions of controller 14 may be incorporated into device electronics 16.

Prior to establishing a USB bus with another device 10′ (or multiple other devices) one of the multiple devices 10/10′ should assume the role of host. Device electronics 16 and port controller 14 may then be appropriately configured in host or slave mode. Establishing which of device 10/10′ will assume this role may be challenging in the absence of an established communication link between device 10 and 10′.

In an example embodiment, devices 10 and 10′ may establish which of these two devices is to assume the role of host as depicted in FIGS. 3, and 6 to 8. Host establishment may be performed by any suitable logic components at devices 10/10′, including by processor 18 or port controller 14, or any other component under suitable software/firmware control. Suitable software/firmware may be stored in non-transitory computer readable memory at the device.

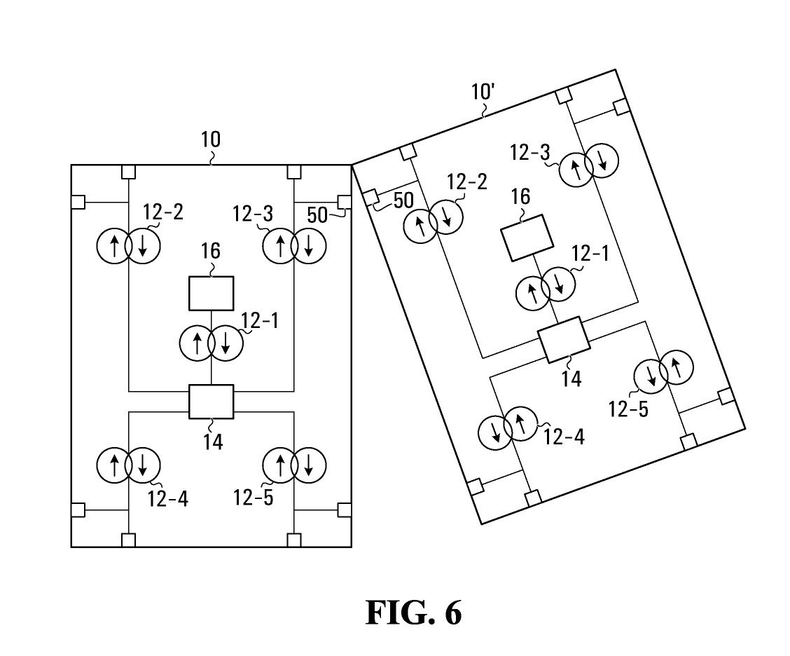

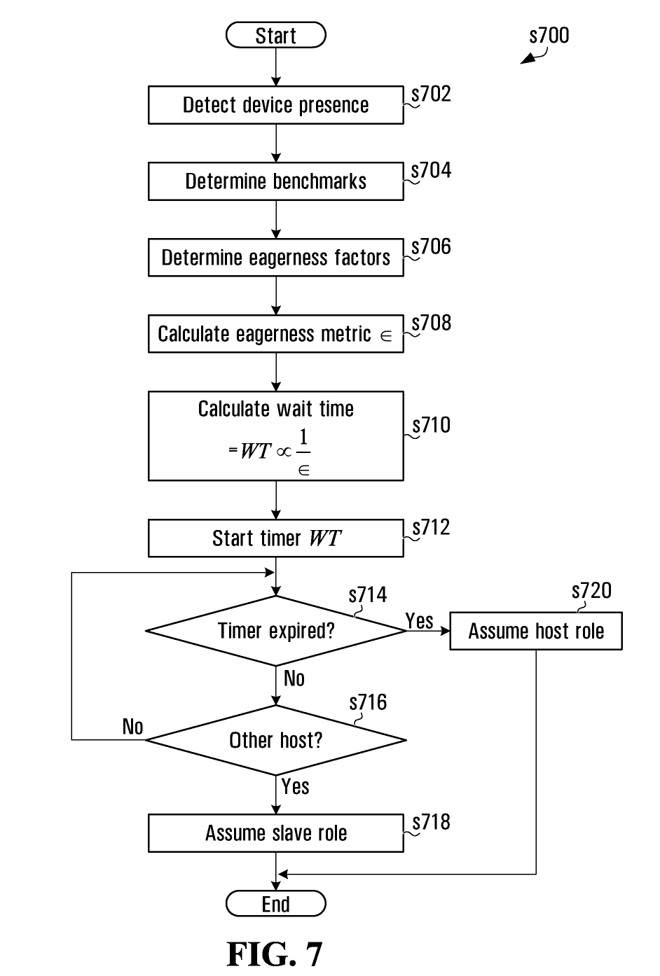

As illustrated in FIG. 7, at block S702, two devices 10 and 10′ are each capable acting a host or a slave are initially brought into proximity, for example by being interconnected—by way of complementary connectors 50 of USB ports 12 of devices 10 and 10′ as illustrated in FIG. 3, or merely by being into contact or proximity with each other, as illustrated in FIG. 6. Each of the two devices 10/10′ may for example detect an electrical connection. Electrical interconnection may be detected, for example, as detailed in the USB Attach Detection Protocol (ADP)—for example by a, change in impedance, capacitance, or voltage at pins of connector 50 of each device, or using a sensor, such as a Hall Effect, capacitive or other sensor.

In response to determining the device presence (e.g. interconnection with another device) at block S702, device electronics 16 (for example processor 18) of each device 10, 10′ causes it respective device to enter a device configuration mode, and determines its own eagerness to act as host. In particular, each device 10, 10′ determines a metric representative of the device's readiness to assume the host mode among devices 10/10′.

In the depicted embodiment, each device 10, 10′ independently calculates an eagerness metric (ε) in block S708 that may be indicative of that device's willingness or ability to act as a host to the other device (i.e. each device 10/10′ performs blocks S700 under control of its own device electronics 16/processor 18).

The eagerness metric (ε) may be calculated based on a number of factors, including for example computing and other resources available at each device 10/10′, determined by benchmarking these in block S704. Serving as a host is more resource intensive than serving as a slave. Accordingly, other things being equal, the device that has the most available resources should serve as the host.

Factors indicative of the device's resources may include available CPU/GPU resources; available memory resources; available network resources; available energy/power (e.g., whether plugged into mains power, battery capacity, battery level); screen solution; etc.

Each processor 18 may, for example, determine available resources using conventional benchmarking techniques in block S704. For example, available resources may be retrieved from sensors on device 10, such as, for example a battery level. For other resources, such as CPU power, conventional scoring/benchmarking techniques may be used. Likewise, conventional network benchmarking techniques/algorithms may be used to determine or score available bandwidths. Some benchmarks, such as CPU/GPU strengths, need only be run once as the scores do not change. Other benchmarks, known to those of ordinary skill, may also be used to determine available resources.

The eagerness metric may also be calculated using data reflecting the resources of the other device. So device 10 may also, or alternatively, calculate its eagerness metric using available information about available resources at device 10′. Such available information may be very limited before devices 10/10′ are able to communicate by way of a USB connection.

Factors indicative of the other device's resources may include detected power available (e.g., detected voltage on USB VCC or data lines of the other device); detected wireless transmission power; stored data regarding the other device's resources, with wireless identification of the other device, e.g., using a broadcasted WiFi or Bluetooth id; pre-stored data regarding whether the other device can become host, with wireless identification of the other device, e.g., using a broadcasted WiFi or Bluetooth ID; detected strong magnetic field strength of the other device (e.g., using a Hall Effect sensor); detected proximity to large ferrous object (e.g., using a pressure sensor in conjunction with a moveable magnet).

Such detected factors indicative of the resources at device 10′ may be provided to device 10. For example, factors indicative of resources at device 10′ may have been provided to device 10 on an earlier occasion—for example, while a communication channel was in existence. Device 10 may then store knowledge of some aspects of resources available at other devices, keyed to a device ID (e.g. MAC address; Bluetooth ID, etc.) for the other devices.

The eagerness metric may also be based on factors indicative of the current operating state of device 10.

For example, applications currently executing at device 10 may wish device 10 to act as host, so as to use resources at device 10′ (e.g., a device 10′ may be more eager to act as host if a video player is executing, for streaming video to slave devices).

Orientation of the device (e.g., landscape or portrait), as may be detected by way of the device's sensors (gyroscope, accelerometer, etc.), may also be used as a factor in calculating the eagerness metric.

The eagerness metric may also be based at least partially on factors indicative of the position or orientation of the device relative to other devices—for example, whether device 10 is to the right or left of another device 10′; whether device 10 is above or below another device 10′; whether devices 10 and 10′ are atop one another etc. This may be determined based on which connector 50 or connectors 50 are being used (e.g., an electrical connection has been detected). This may also be determined using various suitable proximity sensors at device 10/10′.

By way of example, FIG. 3 shows device 10 and device 10′ connected. In some applications, a device on the left (i.e. device 10) should be host (e.g., where a device on the right (i.e. device 10′) may be used as a secondary display. In such an application, device 10 would be more eager to become host than device 10′, and its calculated eagerness metric would reflect this. The bias for a particular side may depend on application settings, user preferences, user characteristics (e.g., whether the user is right handed or left handed).

Ultimately, any other factors used in calculating the eagerness metric (ε) may be collected in block S706 and the eagerness metric (ε), may be calculated in block S708.

For example, ε can be calculated as a weighted mean:

$$ɛ = \frac{{\sum }_{i = 1}^{n} {w}_{i} {RS}_{i}}{{\sum }_{i = 1}^{n} {w}_{i}}$$

where RSᵢ is the resource score for resource i (normalized to be between 0 and 1, higher being better) and w; is the pre-defined weight of resource i.

Next, each device calculates a wait time (WT) for assuming the role of host in block S710. The wait time may be calculated as being generally inversely proportional to how eager the device is to become host. Depending on how the above described metric is calculate, the WT may be calculated as directly or inversely proportion to the calculated metric. If the metric increases with eagerness, WT may be calculated as inversely proportion to the eagerness metric—for example in proportion to 1/ε. If the metric decreases with eagerness (e.g. the metric more accurately measures a device's reluctance to assume the host role), WT may be calculated in proportion to the metric.

In an embodiment, WT may be calculated as

$$W T = \frac{1}{ɛ} {T}_{MIN}$$

where T_{MIN} is a minimum wait time.

For example:

RS₁=0.5, w₁=1 (battery level)
RS₂=0.7, w₂=2 (CPU power)
RS₃=0.4, w₂=2 (bandwidth available)
ε=0.54

### For T_{MIN}=10 ms

WT=18.5 ms

The wait time (WT) will differ from device to device. Device 10 will thus typically calculate a different eagerness metric and wait time in blocks S704-S710 than another device 10′.

Next, a wait interval timer that expires after a wait time interval equal to the wait time (WT) may be started in block S712. The counter may, for example, count up or down a time equal to WT.

Optionally, during the wait time interval, the eagerness metric for each device 10/10′ may be re-calculated as factors change, using a calculus as performed in blocks S704-S708. Accordingly, the wait time for each device 10/10′ may change as the wait interval timer progresses.

During the wait interval, as determined in block S710, each device 10/10′ may wait for a host to appear on its USB bus in block S714, e.g., devices that can only be host, or devices that have chosen to serve as host (including more eager devices). A host may, for example, be detected by device 10 in block S714 by detecting polling signals originated by the host, design to poll for slave devices, as for example detailed in the USB protocols.

Once a host is detected on the bus in block S714, device 10/10′ may elect to assume the role of a slave in block S718 and a USB connection between the host and slave may be established, once blocks S700 are completed. For example, if device 10′ assumes the role of host (as it is more eager—and after its wait time (WT) elapses in block S712), device 10 itself assumes the role of slave in block S718.

If, however, the wait interval timer expires, as determined in block S714, before another device has declared its role as host, device 10 may assume the role of host in block S720. In accordance with the USB protocol, device 10 then begins to poll for slaves at ports 12, to establish a USB bus. Device 10′ could then, for example, detect the presence of device 10 as host in block S714.

If device 10, after assuming its role as host in block S720, does not find any slave within a predetermined time period, it gives up the role of host and operation returns to block S700, and onward.

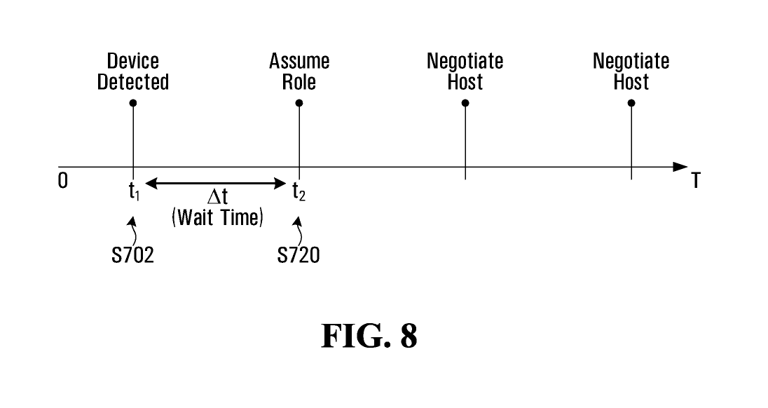

A time line illustrating the operation of device 10 in assuming its role as host, and then negotiation (or attempting to negotiate) its role as host is illustrated in FIG. 8.

Following initial selection of roles, a USB connection is established between devices 10 and 10′. Devices 10/10′ can then exchange information regarding who is more suited to be host. Additional information is available at this stage. For example, accurate information regarding power levels may be exchanged, avoiding the need to estimate based on detected voltage levels.

Once host and slave roles of devices 10 and 10′ have been initially been established, devices 10 and 10′ may assign the roles of each of their ports 12, as for example detailed in U.S. patent application Ser. No. 14/875,224, typically prior to establishing the USB connection.

Roles can be swapped, if necessary, in accordance with USB Host Negotiation Protocol. Roles can be re-negotiated from time to time.

At any time, a user can optionally request all devices to return to their configuration modes, and blocks S700 may be repeated at each device to reset and re-establish host and slave roles. The most eager device then should become host. This may be useful when two devices (both capable of being a host or a slave) that have already assumed host roles are connected.

As should now be appreciated, the above described techniques for allocating host and slave roles and modes can easily be used by two, three or more devices. The multiple devices enter the host assignment mode described above (S700), in response to detecting proximity, interconnection or the like, or in response to a reset. The most eager device, may attempt to assume the role of host as described above, while the remaining device may assume roles as slaves.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A method of configuring an electronic device to assume one of a host mode and a slave mode, among at least two electronic devices, said method comprising:
determining a metric representative of said device's readiness to assume the host mode among said at least two electronic devices;
initiating, based on said metric, a timer that times an amount of time inversely proportional to said device's readiness to assume the host mode among said at least two electronic devices;
prior to expiry of said amount of time, determining if another of said at least two electronic devices has assumed its host mode, and in response thereto assuming said slave mode; and
upon expiry of said amount of time, assuming said host mode.

2. The method of claim 1, further comprising detecting presence of another one of said at least two electronic devices.

3. The method of claim 1, further comprising determining at least one benchmark of resources used at said electronic device, and using said at least one benchmark in determining said metric.

4. The method of claim 3, wherein said at least one benchmark comprises at least one of available memory, available processing power, available network resource, and available electric energy or power at said electronic device.

5. The method of claim 3, wherein said at least one benchmark comprises at least one of available at least one of available memory, available processing power, available network resource, and available electric energy or power at another one of said at least two electronic devices.

6. The method of claim 1, wherein said metric is determined based on data of available resources at another one said at least two electronic devices, determined from information about said another one said at least two electronic devices, stored at said electronic device.

7. The method of claim 6, wherein said data of available resources at said another one said at least two electronic devices is retrieved based on an identification of said at least one of said another one said at least two electronic devices.

8. The method of claim 1, wherein said identification of said another one said at least two electronic devices is based on a wireless identifier of said another one said at least two electronic devices.

9. The method of claim 1, wherein said metric is determined based on the location of said electronic device relative to at least another one of said at least two electronic devices.

10. The method of claim 1, wherein said metric is determined based on at least one application executing at said electronic device.

11. The method of claim 1, wherein said metric is determined based on an orientation of said electronic device.

12. The method of claim 1, wherein said determining if another of said at least two electronic devices has assumed its host mode comprises detecting polling signals from said another of said at least two electronic devices.

13. The method of claim 1, wherein each of said at least two electronic devices is one of a cellular telephone and a tablet computing device.

14. A device comprising:
a plurality of serial ports for interconnection to other electronic devices;
device electronics, operable to act as a host or slave to said other electronic devices and further operable to:
determine a metric representative of said device's readiness to assume the host mode among any other electronic devices;
commence a timer based on said metric that times an amount of time inversely proportional to said device's readiness to assume the host mode among said device and said other electronic devices;
prior to expiry of said amount of time, determine if one of said other electronic devices has assumed its host mode, and in response thereto cause said device electronics to assume their slave mode; and
upon expiry of said amount of time, cause said device electronics to assume their host mode.

15. The device of claim 14, wherein said device electronics are further operable to detect presence of one of said at other electronic devices.

16. The device of claim 14, wherein said device electronics are further operable to determine at least one benchmark of resources used at said device, and wherein said at least one benchmark is used in determining said metric.

17. The device of claim 16, wherein said at least one benchmark comprises at least one of available memory, available processing power, available network resource, and available electric energy or power at said device.

18. The device of claim 16, wherein said at least one benchmark comprises at least one of available at least one of available memory, available processing power, available network resource, and available electric energy or power at another one of said other electronic devices.

19. The device of claim 14, wherein said metric is determined based on data of available resources at another one said at least two electronic devices, determined from information about said another one of said other electronic devices, stored at said device.

20. The device of claim 19, wherein said data of available resources at said another one said other electronic devices is retrieved based on an identification of said another one of said other electronic devices.

21. The device of claim 20, wherein said identification of said another one said at least two electronic devices is based on a wireless identifier of said another one of said other electronic devices.

22. The device of claim 14, wherein said metric is determined based on the location of said device relative to at least one of said other electronic devices.

23. The device of claim 14, wherein said metric is determined based on at least one application executing at said device.

24. The device of claim 14, wherein said metric is determined based on an orientation of said device.

25. The device of claim 16, wherein said determining if one of said other electronic devices has assumed its host mode comprises detecting a polling signal from said one of said other electronic devices.

26. Non-transitory computer readable memory storing processor executable instructions causing the processor to perform the method of claim 1.
